(19) United States
(12) Patent Application Publication
(10) Pub. No.: US 2007/0082323 A1
(43) Pub. Date: Apr. 12, 2007

(54) Method of indicating order and object with indicators of order

(76) Inventor: Jiro Nishi, Ayauta-gun (JP)

Correspondence Address: BEYER WEAVER LLP, P.O. BOX 70250, OAKLAND, CA, 94612-0250, US

(21) Appl. No.: 10/576,569

(22) PCT Filed: Jul. 2, 2004
(86) PCT No.: PCT/JP04/09759

§ 371 Date: Apr. 19, 2006

(30) Foreign Application Priority Data
Nov. 4, 2003 (JP) 2003-374535

(51) Int. Cl. G09B 11/00; G09B 19/00

(52) U.S. Cl. 434/81; 434/98

(57) ABSTRACT

Orders such as a chronological order of historical eras and orders of importance in cultural values of artworks exhibited in a museum are displayed by using the colors of the rainbow.

This application is a continuation of International Application No. PCT/JP2004/009759, filed Jul. 2, 2004 which claims priority on Japanese Patent Application 2003-374535 filed Nov. 4, 2003.

### BACKGROUND OF THE INVENTION

This invention relates to an object comprised of parts that can be ordered in a series such as historical periods and booths at an exhibition, as well as a method of indicating such an order such that a viewer can easily understand the relative position of each part with respect to the other parts.

History books include chapters on different eras arranged in a chronological order but relationships between eras and between eras and events are not made easily understandable by many of them. An exhibition hall includes many booths which may be set along a predetermined route which visitors are expected to follow. This will allow the visitors to circulate smoothly but the visitors will not know their current positions with respect to the entire place of visit. An art museum contains different artworks with nameplates indicating their merits. They may include national treasures and prefectural treasures but only a few visitors usually will know the level of importance of each object being observed.

An attempt may be made to show the ranking in terms of numbers but a mere number will not clearly indicate the relative level of importance unless it is also made clear what the largest assigned number is.

### SUMMARY OF THE INVENTION

It is therefore an object of this invention to provide a method of indicating order of anything that can be ordered such that not only the order of items that can be arranged in a sequence but their position relative to the whole can be easily grasped by the viewer.

It is another object to provide an object which includes items of which the order is thus displayed.

In view of the objects described above, a method according to this invention comprises the steps of individually assigning rainbow colors including red, orange, yellow, green, blue, indigo and violet to parts according to their places in a sequential order and an object according to this invention is characterized as comprising parts that are individually assigned these rainbow colors representing their places in a sequential order. As a result of this invention, a viewer can easily ascertain the places in an order of individual parts being observed with respect to the whole.

### BRIEF DESCRIPTION OF THE DRAWINGS

FIG. 1 shows a method of assigning rainbow colors to historical eras according to this invention.

FIG. 2 is a plan view of a page of a history book embodying this invention.

FIG. 3 shows a method assigning rainbow colors to booths at an exhibition hall according to this invention.

FIG. 4 is a schematic plan view of an exhibition hall arranged according to this invention.

FIG. 5 shows a method of assigning a rainbow colors to exhibited museum items.

FIG. 6 shows an example of an exhibition at a museum.

### DETAILED DESCRIPTION OF THE INVENTION

The invention is applicable, for example, to a history book with chapters on different eras arranged in a chronological order, an exhibition hall with a plurality of booths and an art museum exhibiting artworks of different ranks. These chapters, booths and artworks are each assigned a different one of the rainbow colors such as red, orange, yellow, green, blue, indigo and violet, representing its place in a sequential order. The sequential order may be the chronological order, the order in value or the order in importance.

The rainbow includes seven colors. Peoples of all countries commonly recognize these colors and the order of their appearance. If people according to a certain culture count a smaller number of rainbow colors, the colors used according to this invention may be accordingly varied. If an object contains more than seven parts to be ordered, one or more color bands may be divided into two or more bands of different shadings. A marker with a left-hand side in red and a right-hand side in orange, for example, may be created and assigned to a place (such as a rank) between those corresponding to red and orange. In this way, the total number of color places (ranks) can be increased as the need arises.

Some specific examples of the invention will be described next.

A typical history book of Japan will have chapters of different eras arranged in a chronological order such as the Tumulus period (second half of the third century to the early seventh century), Aska-Nara Era (593-794), Heian Era (794-1,192), Kamakura Era (1,192-1,333), Muromachi-Azuchi Momoyama Era (1,334-1,603), Edo period (1,603-1868) and the modern period (1,868-). If an appropriate part of each page is colored in the rainbow color corresponding to the era being described in that page, the reader can easily find if two or more events being described in the book belong to the same era or not, and the reader can also easily ascertain where that era is in the entire history of Japan. Although there have been books with chapters or sections in different colors, such coloring has merely been for discriminating the chapters or sections from one another and is different from the sequencing and ranking functions of the present invention.

Visitors to an exhibition hall can circulate smoothly if the order for visiting the individual booths is preliminarily fixed. Similarly, visitors to an art museum can move around the exhibits smoothly if the order in which each exhibited item is to be viewed in preliminarily fixed. A suggested route for visitors may be indicated in some halls and museums but such a suggested route indicates merely a route and not the visitor's current location in the whole length of the route.

As artworks of various cultural values are exhibited in an art museum, their nameplates may be colored according to the order of ranking (importance). If an artwork is a designated national treasure, it may be colored in red. If it is merely a prefectural treasure, it may be colored in yellow, for example.

Because each portion (such as a chapter in a book, one of the booths in the hall or an artwork exhibited in a museum) is associated with a rainbow color, the viewer can easily understand its place with reference to the other portions.

The invention is described next by way of embodiments with reference to the drawings.

### First Embodiment

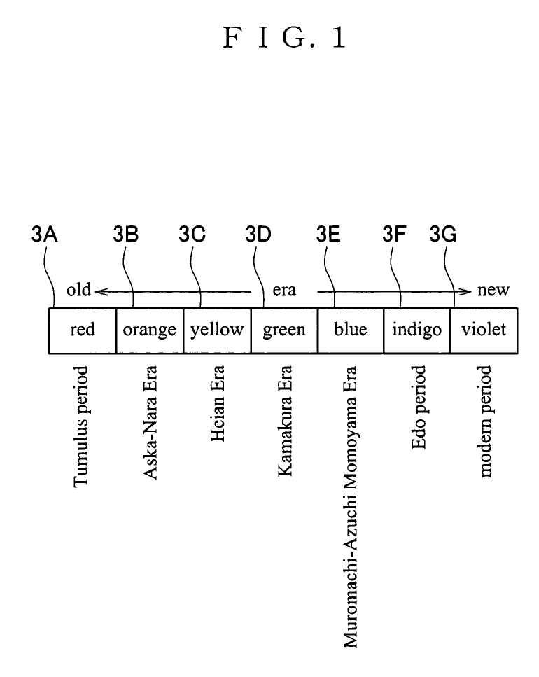

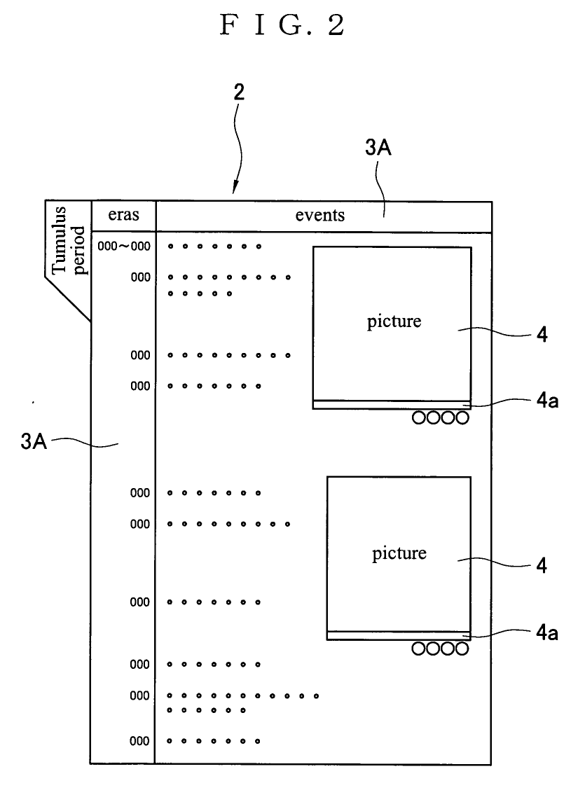

In the first embodiment, the invention is applied to a history book with chapters. As shown in FIG. 1, the seven rainbow colors from red (3A) to violet (3G) are allotted to the seven eras from the Tumulus period to the modern period. FIG. 2 shows a sample page of the book with suitable parts colored in the corresponding colors.

As shown in FIG. 2, the top margin and the outer side margin of the page 2 are colored. The page 2 shown in FIG. 2, of which the top and outer side margins are colored in red (3A), is of the chapter of the Tumulus period. As shown in FIG. 1, red (3A) is allotted to the chapter of the Tumulus period, orange (3B) to the Aska-Nara Era, yellow (3C) to the Heian Era, green (3D) to the Kamakura Era, blue (3E) to the Muromachi-Azuchi Momoyama Era, indigo (3F) to the Edo period, and violet (3G) to the modern period. If the number of eras were larger than seven, each color band would be divided into two or more bands of different shadings. Besides, a marker of which the left-hand half is red and the right-hand half is orange may be created between the red marker and the orange maker. In this way, the number of color markers can be increased. If the number of eras were smaller than seven, only the necessary number of colors commencing from red (3A) would be used, the remaining color or colors being unused. The above classification of eras is of Japan. Each country has its own history and classification of eras.

If a picture 4 is shown on the page 2 and suitable part 4a (the bottom margin in FIG. 2) of the picture 4 is colored in the corresponding color (red (3A) in FIG. 2), the reader can relate the picture 4 to the corresponding era (the Tumulus period in FIG. 2) and learn the history.

The color of a page describing an event and the color of another page describing another event tell whether these two events belong to the same era or not. Besides, each color tells when the event took place in the entire history.

It is preferable to show the allotment of the rainbow colors to eras in a conspicuous part of the history book as shown in FIG. 1.

### Second Embodiment

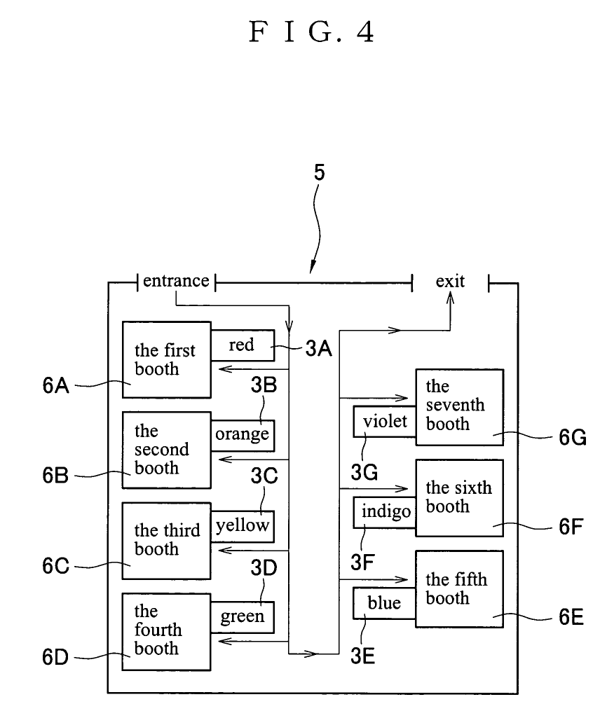

In the second embodiment, the invention is applied to an exhibition hall 5 having seven (first through seventh) exhibition booths 6A-6G arranged along a suggested route for visitors, as schematically shown in FIG. 4.

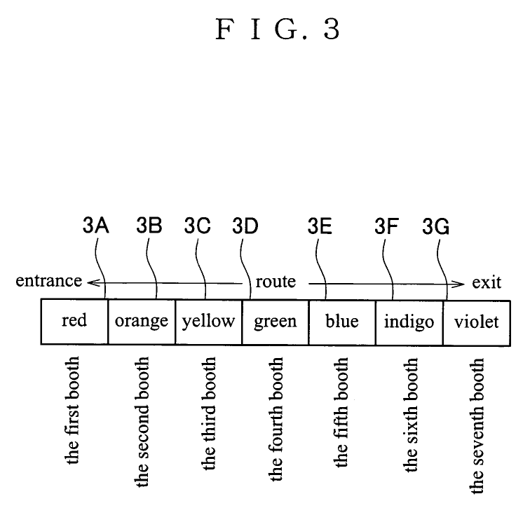

As shown in FIG. 3, the seven rainbow colors from red (3A) to violet (3G) are allotted to the first to seventh booths. If the number of booths were larger than seven, each color band may be divided into two or more bands of different shadings. Besides, a marker of which the left-hand half is red and the right-hand half is orange may be created between the red marker and the orange maker. In this way, the number of color markers can be increased. If the number of booths were smaller than seven, only the necessary number of colors commencing from red (3A) would be used, the remaining color or colors being unused.

In this case, the colors (3A-3G) indicate the order in which the visitors are intended to visit the booths, and the color of each booth tells where the visitor is with respect to the whole length of the route.

It is preferable that the allotment of the rainbow colors to booths as shown in FIG. 3 be shown at the entrance of the exhibition hall 5.

### Third Embodiment

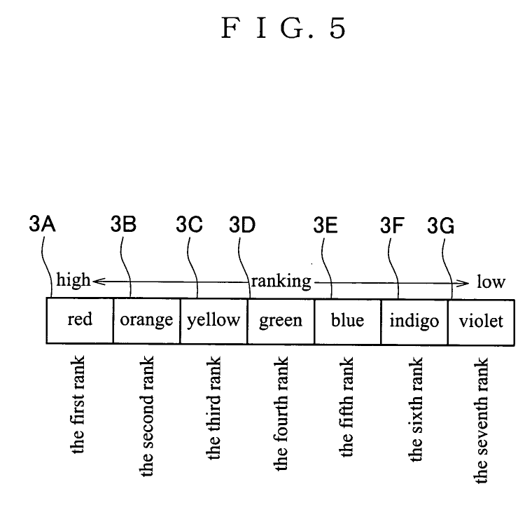

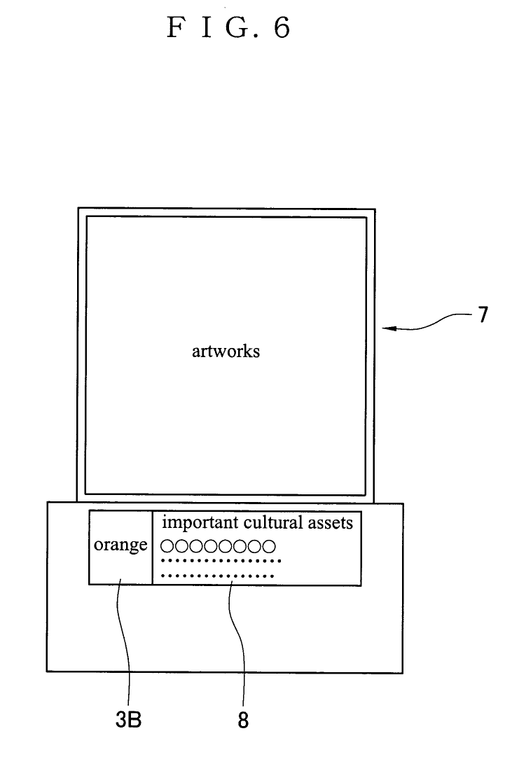

In the third embodiment, the invention is applied to an art museum exhibiting artworks 7 having different cultural values as ranked in FIG. 5. The artworks 7 may be national treasures, important cultural assets, prefectural treasures, tangible cultural assets designated by prefectures, tangible cultural assets designated by municipalities, traditional craft objects designated by prefectures, and so on. As shown in FIG. 6, each of the exhibited artworks 7 is described on a name plate 8 in the color indicative of its ranking. If it is a national treasure, red (3A) is indicated on its nameplate. If it is a designated important cultural asset, orange (3B) is indicated on its nameplate as shown in FIG. 6. If it is a prefectural treasure, yellow (3C) is indicated on its nameplate.

Thus, the museum visitor can learn the rank of each artwork at a glance. The importance of any rank relative to any other ranks can also be learned just as easily. Thus, even the visitors such as foreigners who cannot read the description on the nameplates can understand the ranks of artworks they are observing.

It is preferable that the allotment of the rainbow colors to ranks as shown in FIG. 5 be exhibited at the entrance of the art museum.

What is claimed is:

1. An object comprising parts which are individually assigned rainbow colors including red, orange, yellow, green, blue, indigo and violet, representing places in a sequential order.

2. A method of indicating order for parts for representing places of said parts in a sequential order, said method comprising the steps of individually assigning rainbow colors including red, orange, yellow, green, blue, indigo and violet to said parts.
